(19) United States
(12) Patent Application Publication
(10) Pub. No.: US 2025/0131656 A1
(43) Pub. Date: Apr. 24, 2025

(54) SYSTEM AND METHOD FOR CONTROLLABLE TEXT-TO-3D ROOM MESH GENERATION WITH LAYOUT CONSTRAINTS

(71) Applicant: The Hong Kong University of Science and Technology, Hong Kong (CN)

(72) Inventors: Ping TAN, Hong Kong (CN); Chuan FANG, Hong Kong (CN); Kunming LUO, Hong Kong (CN)

(21) Appl. No.: 18/916,747

(22) Filed: Oct. 16, 2024

Related U.S. Application Data
(60) Provisional application No. 63/592,910, filed on Oct. 24, 2023.

(51) Int. Cl. G06T 19/00; G06F 40/47; G06T 17/20

(52) U.S. Cl. CPC G06T 19/00; G06F 40/47; G06T 17/20; G06T 2200/24; G06T 2210/04; G06T 2210/12

(57) ABSTRACT

A system for generating 3D indoor scenes from text input is provided. It includes a user interface, a text processing module, a scene code generator, a layout generation module, an appearance generation module, a NeRF module, and a PeRF module. The user inputs text describing a room, which is processed into scene codes. These codes guide the generation of a 3D layout using oriented bounding boxes, ensuring spatial integrity. The appearance module then creates a visual representation with a panoramic image. The NeRF module constructs a base 3D model, which is refined by the PERF module for enhanced visual coherence.

### TECHNICAL FIELD

The present invention generally relates to artificial intelligence (AI) is techniques for room image generation. More specifically, the present invention relates to systems and methods for controllable text-to-3D room mesh generation with layout constraints.

### BACKGROUND

High-quality textured 3D models are important for a broad range of applications, from interior design and games to simulators for embodied AI. Indoor scenes are of particular interest among all 3D content. Typically, 3D indoor scenes are manually designed by professional artists, which is time-consuming and expensive. While recent advancements in generative models (dreamfusion, fantasia3d, magic3d, 3DFuse) have simplified the creation of 3D models from textual descriptions, extending this capability to text-driven 3D indoor scene generation remains a challenge because indoor scenes exhibit strong semantic layout constraints (e.g., neighboring walls are perpendicular and the TV set often faces a sofa), which are more complicated than objects.

For existing text-driven 3D indoor scene generation approaches, such as Text2Room and Text2NeRF, they are designed with an incremental framework. They create 3D indoor scenes by incrementally generating different viewpoints frame-by-frame and reconstructing the 3D mesh of the room from these sub-view images. However, their incremental approaches often fail to model the global layout of the room, resulting in unconvincing results that lack semantic plausibility.

For example, one of the generation results of Tex2Room exhibits repeating objects (e.g. several cabinets in a living room), and does not follow the furniture layout patterns. Such the problem is referred to as the “Penrose Triangle problem”, which has plausible 3D structures everywhere locally but lacks global consistency. Moreover, previous methods fail to enable user interactive manipulation as their resulting 3D geometry and texture are uneditable.

Therefore, in the field of indoor scene generation, there is a need for an improved and novel approach to produce plausible 3D structures with consistent interior layouts, along with a user-friendly editable function.

### SUMMARY OF INVENTION

It is an objective of the present invention to provide a system and a method to address the aforementioned issues in the prior arts.

In the present invention, a flexible method for achieving editable and structurally plausible 3D (three-dimensional) indoor scene generation is provided. The method consists of two stages: the layout generation stage and the appearance generation stage. In the layout generation stage, a scene code is used to parameterize the scene layout and learn a text-conditioned diffusion model for text-driven layout generation. In the appearance generation stage, a Control Net model is used for fine-tuning, so as to generate a vivid panoramic image of the room guided by the scene layout. Subsequently, a high-quality 3D room model with a structurally plausible layout and realistic textures is generated. One of the inventive features of this method is its support for interactive 3D scene editing. Furthermore, a mask-guided editing method is proposed, allowing users to adjust the size, placement, and semantic class of furniture in the room.

In accordance with a first aspect of the present invention, a system for computer-based 3D indoor scene assessment generation is provided. The system includes a user interface, a text processing module, a scene code generator, a layout generation module, an appearance generation module, a neural radiance field (NeRF) module, and a panoptic-enhanced radiance field (PeRF) module. The user interface is configured to receive user input regarding a room from a user in a form of text input and convert it into a language or code that is recognized by the system for processing. The text processing module communicates with the user interface and is configured to take the user input and process it into a scene description. The scene code generator communicates with the text processing module and is configured to translate the scene description from the text processing module into a set of scene codes using a scene code diffusion model. The layout generation module communicates with the scene code generator and is configured to generate a 3D layout of the room using oriented bounding boxes based on the scene codes, in which the 3D layout of the room preserves spatial integrity and relationships between objects as specified by the scene codes. The appearance generation module communicates with the layout generation module and is configured to transform the 3D layout of the room from the layout generation module into a visual representation of the room, in which the appearance generation module is further configured to use equirectangular projection to convert the 3D layout of the room into a semantic layout and to generate a single panoramic image of the room based on the semantic layout. The NeRF module communicates with the appearance generation module and is configured to construct a base 3D room model based on the panoramic image, producing a representation of the room by capturing spatial depth. The PERF module communicates with the NeRF module and is configured to refine the base 3D room model by enhancing visual coherence, so as to generate a fully refined 3D room model.

In accordance with a second aspect of the present invention, a method using a system for computer-based 3D indoor scene assessment generation is provided. The method includes steps as follows: receiving, by a user interface, user input regarding a room from a user in a form of text input; converting, by the user interface, the user input into a language or code that is recognized by the system for processing; taking, by a text processing module, the user input and processing it into a scene description; translating, by a scene code generator, the scene description from the text processing module into a set of scene codes using a scene code diffusion model; generating, by a layout generation module, a 3D layout of the room using oriented bounding boxes based on the scene codes, wherein the 3D layout of the room preserves spatial integrity and relationships between objects as specified by the scene codes; transforming, by an appearance generation module, the 3D layout of the room from the layout generation module into a visual representation of the room, wherein the appearance generation module uses equirectangular projection to convert the 3D layout of the room into a semantic layout and generates a single panoramic image of the room based on the semantic layout; constructing, by a NeRF module, a base 3D room model based on the panoramic image, thereby producing a representation of the room by capturing spatial depth; and refining, by a PeRF) module, the base 3D room model by enhancing visual coherence, so as to generate a fully refined 3D room model.

In some embodiments, a computer-implemented method is provided to generate a 3D asset of an indoor scene using a set of trained machine learning models. The method includes: providing a textual description of the indoor scene as input to one of the trained machine learning model; obtaining a 3D bounding box of the room layout; generating, using another fine-tuned machine learning model, based on the 3D room layout, an appealing panoramic image of the room; recovering and texturing the 3D room mesh by depth estimation and surface reconstruction based on the generated panoramic image.

In some embodiments, a computer-implemented method is provided to generate editable 3D asset of indoor scene. The method parameterizes an indoor scene as a holistic scene code that is flexible and supports user interactive editing. The method represents the indoor scene as a panoramic image while considering a physically plausible room layout.

In some embodiments, a computer-implemented method is provided to generate and edit panoramic images. The method achieves high-quality results with loop consistency through a pre-trained latent image diffusion model, without the need for expensive editing-specific training.

By the configuration above, positive effects are achieved as follows:
(1): A two-stage method for 3D room generation from text input is designed. The method separates the generation of geometric layout and visual appearance, allowing room layout constraints to be captured from real-world data while creating visually appealing results simultaneously.
(2): The separation of geometric layout and visual appearance provides flexible control and editing over the generated 3D room model. Users can easily adjust the size, semantic class, and position of furniture items.
(3) A novel method for generating and editing panoramic images is presented. This method achieves high-quality results with loop consistency using a pre-trained latent image diffusion model, eliminating the need for expensive, editing-specific training.

### BRIEF DESCRIPTION OF DRAWINGS

Embodiments of the invention are described in more details hereinafter with reference to the drawings, in which:

FIG. 1 depicts a schematic diagram of a model framework of a system for computer-based 3D indoor scene assessment generation according to some embodiments of the present invention;

FIG. 2 depicts a schematic diagram of a method using system for the generation of a 3D room model, according to some embodiments of the present invention; and

FIG. 3A, FIG. 3B, FIG. 4A, FIG. 4B, FIG. 5A, and FIG. 5B provide qualitative demonstrations of the system using the method as described in some embodiments of the present invention.

### DETAILED DESCRIPTION OF THE INVENTION:

In the following description, systems and methods for controllable text-to-3D room mesh generation with layout constraints and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

Text-driven 3D indoor scene generation has potential applications in gaming, the film industry, and AR/VR. However, existing methods fail to accurately capture room layouts and lack the ability to flexibly edit individual objects within the room. To address these problems, in the present disclosure, a solution “Ctrl-Room” is presented as a system capable of producing realistic 3D rooms with designer-style layouts and high-quality textures based on a simple text prompt. Furthermore, interactive editing operations like resizing or moving furniture items are allowed. The approach is based on the separation of layout modeling and appearance generation. It consists of two stages: the “Layout Generation Stage,” where a text-conditional diffusion model is trained to learn the layout distribution using a holistic scene code parameterization, and the “Appearance Generation Stage,” where a fine-tuned ControlNet is employed to generate a vivid panoramic image of the room guided by the 3D scene layout and text prompt. This enables the creation of high-quality 3D rooms with realistic layouts and lively textures. With the scene code parameterization, the generated room model can easily be edited using a mask-guided editing module, without requiring specialized training for expensive editing tasks. Overall, Ctrl-Room provides a powerful solution for text-driven 3D indoor scene generation in various applications such as gaming, the film industry, and AR/VR.

The following describes methods, systems, and computer-readable media for the generation of three-dimensional (3D) editable assets of indoor scenes from corresponding textual descriptions (e.g., computer-based 3D indoor scene asset generation).

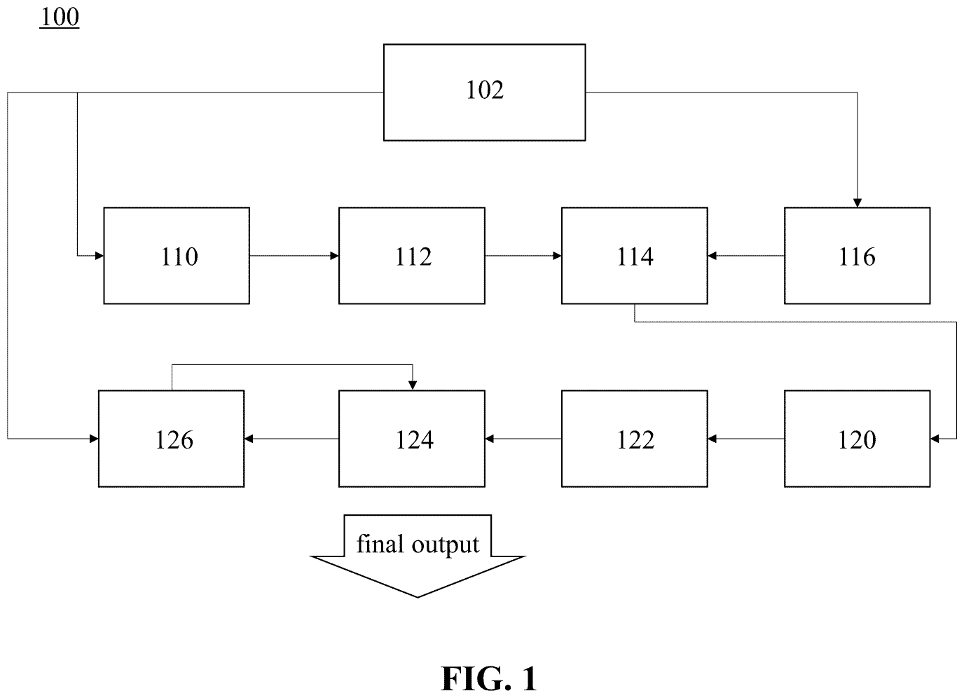

FIG. 1 depicts a schematic diagram of a model framework of a system 100 for computer-based 3D indoor scene assessment generation according to some embodiments of the present invention. The system 100 includes a user interface 102, a text processing module 110, a scene code generator 112, a layout generation module 114, and a layout modification module 116, an appearance generation module 120, a NeRF (neural radiance field) module 122, a PeRF (panoptic-enhanced radiance field) module 124, and a panoramic update module 126.

These components are arranged for a two-stage method to achieve editable and physically plausible 3D room meshes generation from text prompts. The two-stage includes a layout generation stage and an appearance generation stage. The text processing module 110, the scene code generator 112, the layout generation module 114, and the layout modification module 116 collaborate during a layout generation stage. The appearance generation module 120, the NeRF module 122, the PERF module 124, and the panoramic update module 126 collaborate during an appearance generation stage.

The layout generation stage including a holistic scene code is configured to parameterize a room layout that supports flexible user editing and to provide a generative model (e.g., layout generation module 114) to learn the distribution of the room layout. The appearance generation stage includes a fine-tuned generative model (e.g., NeRF module 122/PeRF module 124) to produce vivid panoramic image of the indoor scene with the room layout constraints and to generate/provide a high-quality 3D room with a structurally plausible layout and realistic textures. Further, users are allowed to adjust size, placement, and/or semantic class of furniture (via the user interface 102 at least) in the room with a mask guided editing option.

The user interface 102 is configured to receive user inputs regarding a room in a form of text or other types of input. The user inputs may relate to the desired type of room (e.g., living room, study room, or bedroom). The user interface 102 can convert these inputs into a language or code that the system 100 can recognize and process. By translating user inputs into a system-readable format, the user interface 102 ensures that these inputs are effectively passed to the corresponding components within the system 100. These components can then generate appropriate responses based on the user's input, allowing for interaction and communication between the user and the system 100.

The text processing module 110 communicates with the user interface 102 and is configured to take at least one user-provided text prompt (e.g., the user input) and process it into a scene description. Accordingly, the input to the text processing module 110 is the text prompt, and the output from the text processing module 110 is the scene description.

The scene code generator 112 communicates with the text processing module 110 and is configured to translate the scene description from the text processing module 110 into a tunable scene code using a scene code diffusion model. Specifically, the scene code generator 112 include a scene code diffusion model. During the translation, the scene code generator 112 receives the scene description from the text processing module 110 and processes it through multiple layers of a QKV (Query, Key, Value) mechanism via the scene code diffusion model. The scene code diffusion model is configured to gradually refine the scene description into a structured representation. During this translation, scene code noise is embedded to introduce variation and flexibility, allowing for a more robust generation of the scene. As the diffusion progresses, the noise is iteratively reduced, and the scene code generator 112 can output a set of scene codes that represent the scene structure, which is ready for further processing or rendering. Accordingly, the input to the scene code generator 112 is scene description and the output from the scene code generator 112 is a set of scene codes.

The layout generation module 114 communicates with the scene code generator 112 and is configured to generate a 3D layout of a room using oriented bounding boxes based on the scene codes. In this regard, the scene codes generated by the scene code generator 112 can serve as a structured representation of the room's elements and spatial relationships. The layout generation module 114 takes the set of the scene codes as input, translating them into a 3D layout by positioning and sizing objects within the room using oriented bounding boxes. These bounding boxes represent key objects or key factors in the scene, such as walls, furniture, or fixtures, and provide a modular way to define the geometry and arrangement of the room. The output from the layout generation module 114 is a 3D layout of the room, which preserves the spatial integrity and relationships between objects as specified by the scene codes. Accordingly, the input to the layout generation module 114 is the set of the scene codes, and the output from the layout generation module 114 is a 3D layout of a room.

The layout modification module 116 communicates with the layout generation module 114 and is configured to allow users to modify the layout interactively (e.g., change position, size of objects, in which the modification request may be fed by the user interface 102 to the layout modification module 116). Specifically, the layout modification module 116 receives the 3D layout of the room and display the same for the user (e.g., who provides the input initially to the system 100). The layout modification module 116 provides an interface such that the user can adjust at least one of the scene codes based on the displayed 3D layout of the room, such as changing the position or size of objects within the scene (i.e., within the room), offering flexibility of the system 100. In this regard, the modification by the user can directly change the applied scene codes, which represent the structural and spatial properties of the objects. For example, when a user changes the position or size of an object, the layout modification module 116 updates the relevant scene codes to reflect these changes, ensuring that the system 100 remains flexible, maintaining consistency between the visual representation and the scene data. By offering interactive and dynamic control over the room layout, the layout modification module 116 enhances user engagement and allows for personalized room designs that can be easily adapted to specific preferences or requirements. Accordingly, the input to the layout modification module 116 is the 3D layout of the room, and the output from the layout modification module 116 is update data for the 3D layout of the room.

The appearance generation module 120 communicates with the layout generation module 114 and is configured to transform a 3D room layout (e.g., the 3D layout of the room from the layout generation module 114) into a visual representation of the room. The appearance generation module 120 uses equirectangular projection to convert the detailed layout provided by the layout generation module 114 into a semantic layout. The semantic layout captures the spatial relationships and object placements within the room, thereby generating a visual representation in response to the user input.

Following this conversion, the appearance generation module 120 employs loop-consistent sampling techniques to ensure that the generated visuals maintain spatial and contextual coherence. In one embodiment, the conversion is achieved through a ControlNet model, which is a neural network for refining the visual output by maintaining consistency across different viewpoints. The result by the appearance generation module 120 is a single panoramic image that comprehensively represents the room's visual details. Accordingly, the input to the appearance generation module 120 is the 3D layout from the layout generation module 114, and the output from the appearance generation module 120 is a single panoramic image of the room.

The NeRF module 122 communicates with the appearance generation module 120 and is configured to construct/create a base 3D room model based on the panoramic image generated by the appearance generation module 120. The NeRF module 122 produces a representation of the room by capturing spatial depth within the scene. In this regard, the NeRF module 122 leverages neural radiance techniques and analyzes the panoramic image, such that the NeRF module 122 can capture and reconstruct the spatial depth and intricacies of the scene. It processes the image to discern object surfaces and spatial relationships within the room, ensuring that the base 3D room model reflects the visual appearance of the room. Accordingly, the input to the NeRF module 122 is the panoramic image generated by the appearance generation module 120, and the output from the NeRF module 122 is a base 3D room model (e.g., a NeRF model for a room) with realistic textures and spatial consistency. The outcome from the NeRF module 122 is provided to the PeRF module 124 for enhancement, which focuses on layout-guided 3D rendering.

The PERF module 124 communicates with the NeRF module 122 and is configured to refine the base 3D room model generated by the NeRF module 122, incorporating layout constraints to ensure spatial consistency and semantic accuracy. The step by the PERF module 124 can enhance the room's visual coherence by aligning the objects' positions, sizes, and textures with the layout. Accordingly, the output from the PERF module 124 is a fully refined 3D room model (e.g., a layout-guided PeRF model for a room).

The panoramic update module 126 communicates with the PERF module 124 and is configured to update the panorama and 3D room model dynamically based on any modifications made to the layout by the user (for example, the modification request input from the user interface 102 to the panoramic update module 126), such as changes in object placement or size. The panoramic update module 126 can ensure that the updated layout is reflected in both the panoramic image and the 3D room model. For example, when a user reviews the fully refined 3D room model presented by the PERF module 124 and makes modifications, the panoramic update module 126 dynamically updates the 3D room model and requests the appearance generation module 120, the NeRF module 122, and the PERF module 124 to regenerate a 3D room model based on the user's changes. This allows the corresponding components to produce a revised 3D room model that better aligns with the user's latest requirements. Then, the PERF module 124 provides the final output of the 3D room model.

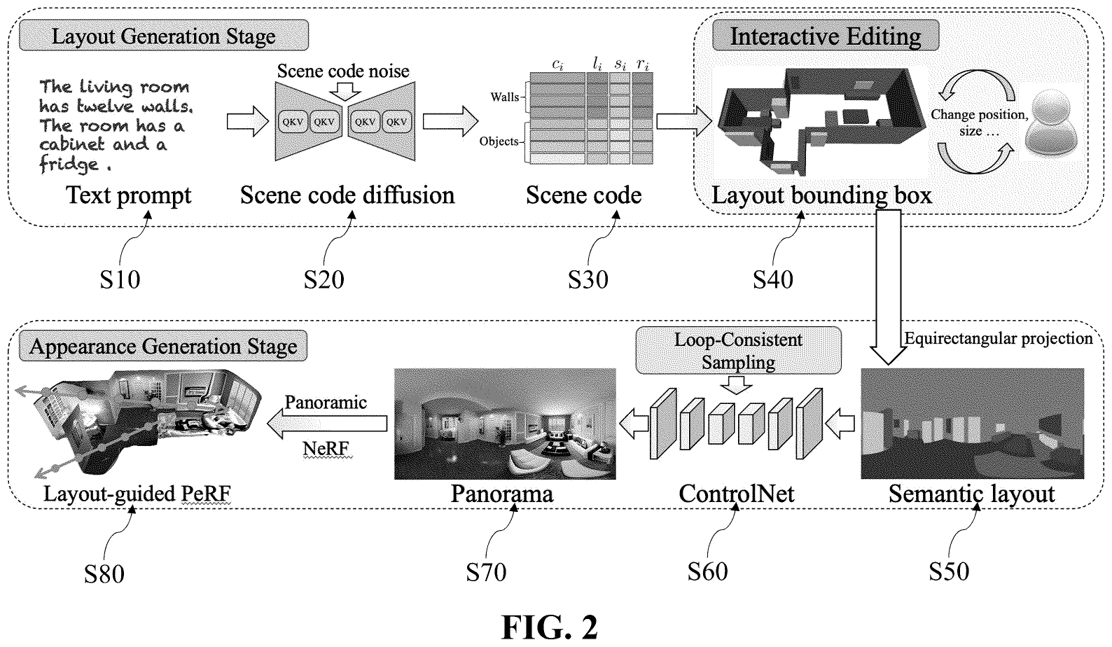

FIG. 2 depicts a schematic diagram of a method using system 100 for the generation of a 3D room model, according to some embodiments of the present invention. In the present invention, the proposed method is referred as to a CtrlRoom solution, achieving controllable text-to-3D room meshes generation with layout constraints. Briefly, the proposed method involves a 3D room modeling process, divided into two stages including a layout generation stage and an appearance generation stage. In the layout generation stage, the purpose is to generate a 3D scene layout from the input text. In the appearance generation stage, the purpose is to generate a single panoramic to represent the appearance which is guided by the scene layout. After the appearance generation stage, the expected outcome is reconstruction of a fully 3D room model. During the generation process, the flexible scene layout representation, defined by a set of oriented bounding boxes, allows users to perform flexible editing operations. For example, after a user moves a chair, the method includes generating a new panorama based on the updated scene layout, and the 3D room model is then updated accordingly.

As shown in FIG. 2, the layout generation stage includes steps S10, S20, S30, and S40. In step S10, a text prompt is provided by the user, who enters it via the user interface 102. The text processing module 110 then processes the text prompt. In step S20, scene code diffusion is initiated by the scene code generator 112 based on the text prompt. In step S30, a set of scene codes is generated by the scene code generator 112. This set of scene codes can be recorded in a user-friendly format. In one embodiment, the scene codes are represented in a structured table that the rows represent different entities (such as “Walls” or “Objects”) in the scene and the columns (such as Ci, Li, Si, Ri) correspond to different attributes or parameters associated with each entity/element. For example, the attributes or parameters include the category or class of the element, the location or layout information, the size or scale of the element, and the orientation or rotation of the element. This tabular format facilitates easier control, generation, and modification of the scene layout programmatically based on the scene codes. In step S40, an initial 3D layout of a room is generated using oriented bounding boxes by the layout generation module 114, based on the scene codes. During the generation of the initial 3D layout, the system 100 allows for interactive user modifications via the layout modification module 116, such as changing the position or size of objects within the scene, allowing at least one of the scene codes to be adjusted by the user, thus offering flexibility.

Next, the appearance generation stage includes steps S50, S60, S70, and S80, which work in conjunction to create a 3D room model. In step S50, the appearance generation module 120 performs an equirectangular projection using the output from the layout generation stage to produce a semantic layout. This semantic layout encodes essential spatial information about the room and its objects, enabling appearance generation. In step S60, the appearance generation module 120 applies loop-consistent sampling in conjunction with a ControlNet model network to generate a single panoramic view, which captures the visual details of the entire room from a 360-degree perspective. The loop-consistent sampling ensures that the visual appearance remains coherent across different areas of the panorama. In step S70, the NeRF module 122 uses the panoramic view to reconstruct a base 3D room model, incorporating spatial depth into the scene. The NeRF model primarily focuses on capturing the structural details of the base 3D room model. In step S80, the PERF module 124 refines the base 3D room model by incorporating layout constraints, ensuring that the objects' positions, sizes, and orientations align with the intended design. The resulting layout-guided 3D room model can be further updated through the panoramic update module 126, which allows for dynamic revisions if the user makes changes to the layout, such as moving or resizing objects. This capability provides flexibility for iterative design and real-time adjustments. After step S80, the 3D room modeling process is considered complete, producing a final 3D room model that is ready for use or visualization.

The proposed method achieves the following effects: a separated two-stage generation process; compact layout generation and layout-guided panoramic image generation; and flexible control and editing of the generated 3D room model by the user. As compared to Text2Room, the proposed method is able to generate plausible layout and vivid appearance. Herein, the phrase “separated two-stage generation process” means that the generation of the 3D layout of the room by the appearance generation module and the generation of the base 3D room model by the NeRF module are distinct stages performed sequentially.

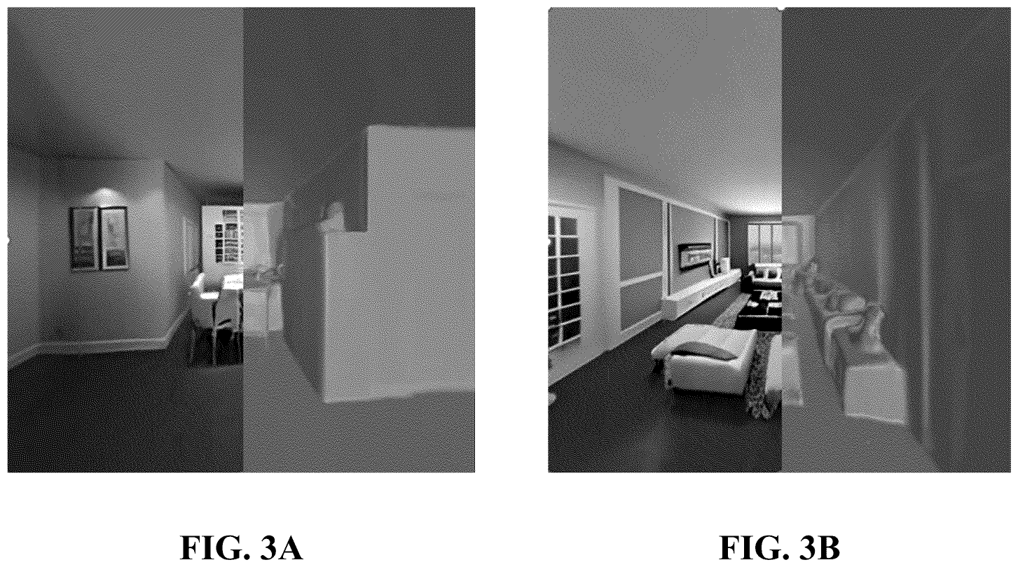

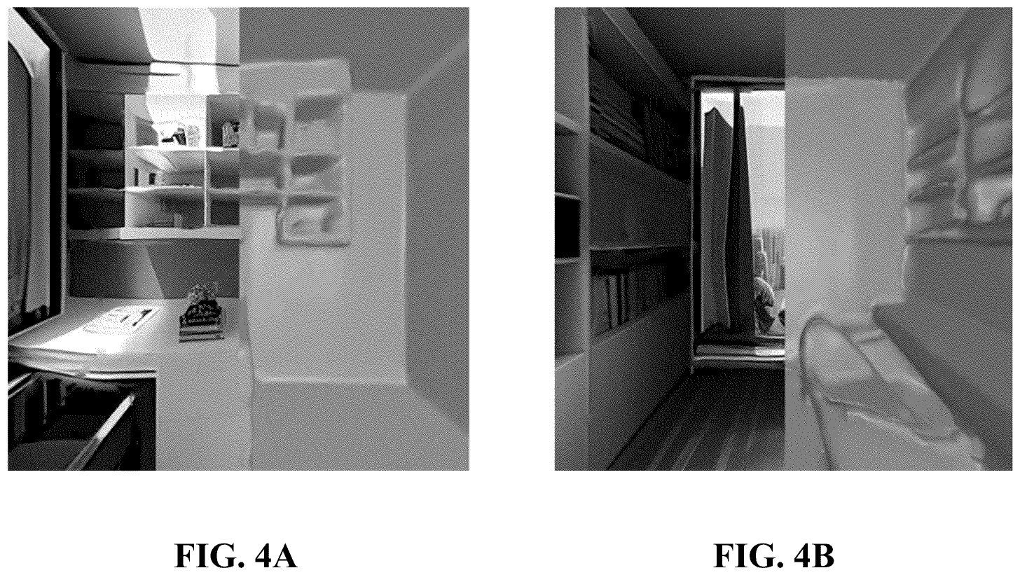

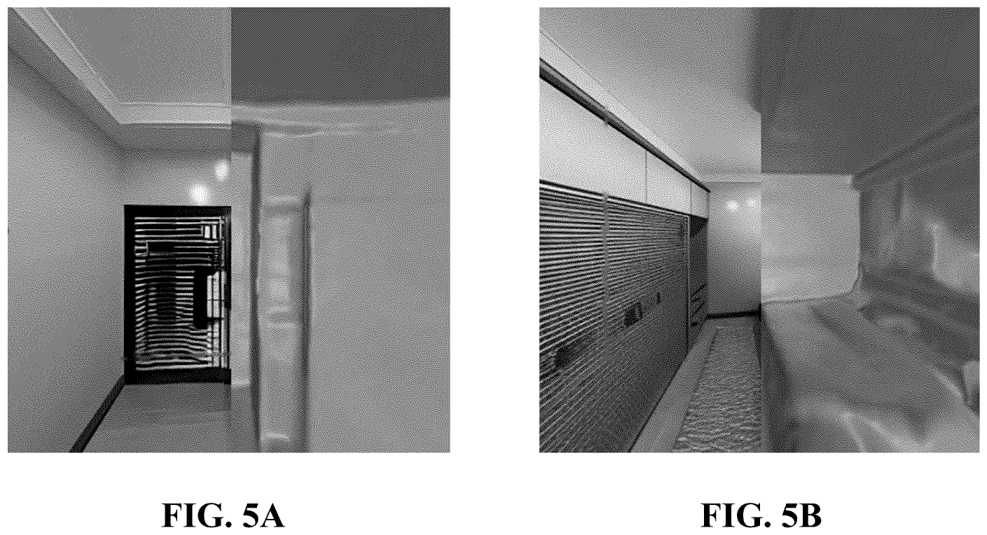

FIG. 3A, FIG. 3B, FIG. 4A, FIG. 4B, FIG. 5A, and FIG. 5B provide qualitative demonstrations of the system 100 using the method as described in some embodiments of the present invention. FIG. 3A and FIG. 3B demonstrate a living room model; FIG. 4A and FIG. 4B demonstrate a study room model; FIG. 5A and FIG. 5B demonstrate a bedroom model. In each illustration, the left side displays colored renderings of the generated 3D room models, while the right side presents geometric renderings to highlight the geometric quality of the results provided by the method. Thus, the proposed method can generate various common room types and follows a professional designer-style room layout.

As discussed above, the proposed system and method introduce a two-stage approach for generating 3D room meshes from text input, focusing on geometric layout generation and appearance generation. This separation allows for better capture of real-world layout constraints while producing vivid and detailed visual appearances. A key benefit of the method is its flexibility, enabling users to easily adjust the size, semantic class, and position of furniture items within the generated 3D room model. Additionally, the method includes a novel approach for generating and editing panoramic images using a pre-trained latent image diffusion model, ensuring high-quality results without the need for expensive editing-specific training. As such, this flexible, efficient process makes it suitable for creating and manipulating 3D assets for indoor scenes based on textual descriptions and user interaction.

The two-stage generation approach optimizes computational efficiency by leveraging a structured workflow. The separation of layout modeling from appearance generation ensures that each stage focuses on its specific task, reducing the computational load during each phase. This separation leads to reduced power consumption during operation as the system efficiently manages resources. Additionally, the method speeds up computation by handling complex tasks in distinct stages, ultimately maximizing computational efficiency and enhancing overall performance.

The functional units and modules of the system and methods in accordance with the embodiments disclosed herein may be embodied in hardware or software. That is, the claimed system may be implemented entirely as machine instructions or as a combination of machine instructions and hardware elements. Hardware elements include, but are not limited to, computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

The system may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

The system may also be configured as distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application. thereby enabling others skilled in the art to understand the invention for various embodiments and with various modifications that are suited to the particular use contemplated.

1. A system for computer-based 3D indoor scene assessment generation, comprising:
a user interface configured to receive user input regarding a room from a user in a form of text input and convert it into a language or code that is recognized by the system for processing;
a text processing module communicating with the user interface and configured to take the user input and process it into a scene description;
a scene code generator communicating with the text processing module and configured to translate the scene description from the text processing module into a set of scene codes using a scene code diffusion model;
a layout generation module communicating with the scene code generator and configured to generate a 3D layout of the room using oriented bounding boxes based on the scene codes, wherein the 3D layout of the room preserves spatial integrity and relationships between objects as specified by the scene codes;
an appearance generation module communicating with the layout generation module and configured to transform the 3D layout of the room from the layout generation module into a visual representation of the room, wherein the appearance generation module is further configured to use equirectangular projection to convert the 3D layout of the room into a semantic layout and to generate a single panoramic image of the room based on the semantic layout;
a neural radiance field (NeRF) module communicating with the appearance generation module and configured to construct a base 3D room model based on the panoramic image, producing a representation of the room by capturing spatial depth; and
a panoptic-enhanced radiance field (PeRF) module communicating with the NeRF module and configured to refine the base 3D room model by enhancing visual coherence, so as to generate a fully refined 3D room model.

2. The system according claim 1, wherein the generation of the 3D layout of the room by the appearance generation module and the generation of the base 3D room model by the NeRF module are distinct stages performed sequentially.

3. The system according claim 1, wherein the scene code generator receives the scene description from the text processing module and processes it through multiple layers of a QKV (Query, Key, Value) mechanism via the scene code diffusion model, which is configured to gradually refine the scene description into a structured representation.

4. The system according claim 3, wherein, during a translation by the scene code diffusion model, scene code noise is embedded by the scene code diffusion model to introduce variation and flexibility.

5. The system according claim 1, wherein the layout generation module uses the oriented bounding boxes which represent key objects or key factors in a scene of the room for providing a modular way to define geometry and arrangement of the room.

6. The system according claim 1, further comprising:
a layout modification module communicating with a layout generation module and configured to allow the user to modify the 3D layout of the room interactively, wherein the layout modification module is further configured to provides an interface such that the user is permitted to adjust at least one of the scene codes based on the displayed 3D layout of the room via the interface and that the applied scene codes are directly changed.

7. The system according claim 6, wherein the layout modification module is further configured to update the applied scene codes to reflect modification by the user, maintaining consistency between the visual representation and scene data for the room.

8. The system according claim 1, wherein the semantic layout captures spatial relationships and object placements within the room, thereby generating the visual representation in response to the user input.

9. The system according claim 1, wherein the appearance generation module generate the single panoramic image of the room via employs loop-consistent sampling using a ControlNet model.

10. The system according claim 1, further comprising:
a panoramic update module communicating with the PeRF module and configured to update the panorama or the fully refined 3D room model dynamically based on any modifications made by the user, when the user reviews the fully refined 3D room model presented by the PeRF module and makes modifications.

11. A method using a system for computer-based 3D indoor scene assessment generation, comprising:
receiving, by a user interface, user input regarding a room from a user in a form of text input;
converting, by the user interface, the user input into a language or code that is recognized by the system for processing;
taking, by a text processing module, the user input and processing it into a scene description;
translating, by a scene code generator, the scene description from the text processing module into a set of scene codes using a scene code diffusion model;
generating, by a layout generation module, a 3D layout of the room using oriented bounding boxes based on the scene codes, wherein the 3D layout of the room preserves spatial integrity and relationships between objects as specified by the scene codes;
transforming, by an appearance generation module, the 3D layout of the room from the layout generation module into a visual representation of the room, wherein the appearance generation module uses equirectangular projection to convert the 3D layout of the room into a semantic layout and generates a single panoramic image of the room based on the semantic layout;
constructing, by a neural radiance field (NeRF) module, a base 3D room model based on the panoramic image, thereby producing a representation of the room by capturing spatial depth; and
refining, by a panoptic-enhanced radiance field (PeRF) module, the base 3D room model by enhancing visual coherence, so as to generate a fully refined 3D room model.

12. The method according claim 11, wherein the generation of the 3D layout of the room by the appearance generation module and the generation of the base 3D room model by the NeRF module are distinct stages performed sequentially.

13. The method according claim 11, wherein the scene code generator receives the scene description from the text processing module and processes it through multiple layers of a QKV (Query, Key, Value) mechanism via the scene code diffusion model, which is configured to gradually refine the scene description into a structured representation.

14. The method according claim 13, wherein, during a translation by the scene code diffusion model, scene code noise is embedded by the scene code diffusion model to introduce variation and flexibility.

15. The method according claim 11, wherein the layout generation module uses the oriented bounding boxes which represent key objects or key factors in a scene of the room for providing a modular way to define geometry and arrangement of the room.

16. The method according claim 11, further comprising:
allowing, by the layout modification module, the user to modify the 3D layout of the room interactively, wherein the layout modification provides an interface such that the user is permitted to adjust at least one of the scene codes based on the displayed 3D layout of the room via the interface and that the applied scene codes are directly changed.

17. The method according claim 16, wherein the layout modification updates the applied scene codes to reflect modification by the user, maintaining consistency between the visual representation and scene data for the room.

18. The method according claim 11, wherein the semantic layout captures spatial relationships and object placements within the room, thereby generating the visual representation in response to the user input.

19. The method according claim 11, wherein the appearance generation module generate the single panoramic image of the room via employs loop-consistent sampling using a ControlNet model.

20. The method according claim 11, further comprising:
updating, by a panoramic update module, the panorama or the fully refined 3D room model dynamically based on any modifications made by the user, when the user reviews the fully refined 3D room model presented by the PeRF module and makes modifications.
